(19) United States
(12) Patent Application Publication
(10) Pub. No.: US 2014/0156879 A1
(43) Pub. Date: Jun. 5, 2014

(54) ACTIVE CABLE WITH INDICATORS SHOWING OPERATING MODES AND LINKING STATUS

(71) Applicant: SAE Magnetics (H.K.) Ltd., Hong Kong (HK)

(72) Inventors: Kwok Leung WONG, Hong Kong (HK); Yuanfan WENG, Hong Kong (HK)

(73) Assignee: SAE Magnetics (H.K.) Ltd., Hong Kong (HK)

(21) Appl. No.: 14/084,582

(22) Filed: Nov. 19, 2013

Related U.S. Application Data
(60) Provisional application No. 61/732,413, filed on Dec. 3, 2012.

(51) Int. Cl. G06F 11/30

(52) U.S. Cl. CPC G06F 11/3051
USPC 710/19

(57) ABSTRACT

An active cable includes: a cable body with two ends and two cable plugs being connected to the two ends of the cable body respectively. Each cable plug includes: an electrical connector configured for transmitting and receiving power, high speed data and low speed control signals; a transceiver circuitry connected with the electrical connector and the cable body and configured to transmit and receive the high speed data between the electrical connector and the cable body; an indicator; a driving circuitry connected with the indicator and configured to drive the indicator; and a cable controller connected with the electrical connector, the transceiver circuitry and the driving circuitry and configured to determine an operating mode and linking status of the active cable and transmit an internal control signal to the driving circuitry accordingly.

### CROSS-REFERENCE TO RELATED APPLICATIONS

This application claims the benefit of U.S. Provisional Patent Application No. 61/732,413 filed on Dec. 3, 2012, the contents of which is hereby incorporated by reference.

### FIELD OF THE PATENT APPLICATION

The present patent application generally relates to opto-electrical interconnect technologies and more specifically to an active cable with indicators showing different operating modes and linking status.

### BACKGROUND

For modern data transmission systems, there are typically many working states. For example, a PC host is using the S-states to represent states for different power consumption conditions: S0 (normal), S1 to S4 (sleep states) and S5 (shut-down). For the purpose of saving power, the cable can be driven into different operating modes. Such modes include an active mode (normal, with high speed data transmission), or an idle mode (less power consumption than in active mode, and no high speed data is being transmitted). In the idle mode the cable is usually carrying low speed control signals between the host and peripherals. There is also a sleep mode, in which the system is in the lowest possible power consumption state, and the cable is standing by and waiting for any wake up signals. Moreover, the cable may contain more than one channel for data transmission. When cables connected between, for example, a peripheral device and a host for transmitting data or signal, the user cannot visually determine the operating modes and link status of the transmission cable directly. If the connection between the peripheral device and host is unsuccessful, the user cannot know the situation immediately. It is also possible that the user inadvertently interrupts the data transmission by unplugging the cable when there is an on-going data transmission through the cable, which not only causes data transmission failure but also may have the possibility of damaging the devices and the cable.

### SUMMARY

The present patent application is directed to an active cable. In one aspect, the active cable includes: a cable body with two ends; and two cable plugs being connected to the two ends of the cable body respectively. Each cable plug includes: an electrical connector configured for transmitting and receiving power, high speed data and low speed control signals; a transceiver circuitry connected with the electrical connector and the cable body and configured to transmit and receive the high speed data between the electrical connector and the cable body; an indicator; a driving circuitry connected with the indicator and configured to drive the indicator; and a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status.

The cable plug may further include a printed circuit board and an insulating housing. The transceiver circuitry, the indicator, the driving circuitry, and the cable controller may be assembled on the printed circuit board. The insulating housing may be enclosing the indicator.

The cable plug may further include a light guide. The insulating housing may include an illumination area. The illumination area may be aligned with the light guide and the indicator so that light emitted from the indicator passes through the light guide and transmits out from the illumination area.

The cable body may include a copper wire. The electrical connector may include a power line. The copper wire may be connected with the power line and configured to transmit electrical power. The cable body may include an optical fiber, and the transceiver circuitry may be configured to convert the high speed data from the electrical connector into an optical signal to be coupled into the optical fiber and to covert the optical signal from the optical fiber into an electrical data to be transmitted into the electrical connector. The cable controller may be configured to command the transceiver circuitry to transmit and receive a low speed control signal through the optical fiber.

The cable body may include a copper wire being connected with the transceiver circuitry and configured for transmitting and receiving high speed data.

The cable body may include a copper wire being connected with the electrical connector and the cable controller and configured for transmitting and receiving a low speed control signal.

The transceiver circuitry may be further configured to recondition the high speed data with clock data recovery (CDR). The indicator may be a light-emitting diode (LED) or a liquid-crystal display (LCD). The pattern may be presented by a combination of on/off duty cycle, brightness and color of the indicator. The cable controller may be configured to transmit an internal control signal to the driving circuitry to control the brightness of the indicator using PWM (Pulse Width Modulation).

In another aspect, the active cable includes a cable body with two ends; and two cable plugs being connected to the two ends of the cable body respectively. Each cable plug includes: an electrical connector configured for transmitting and receiving power, high speed data and low speed control signals; a transceiver circuitry connected with the electrical connector and the cable body and configured to transmit and receive the high speed data between the electrical connector and the cable body; an indicator; a driving circuitry connected with the indicator and configured to drive the indicator; a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status; a printed circuit board; and an insulating housing. The transceiver circuitry, the indicator, the driving circuitry, and the cable controller are assembled on the printed circuit board. The insulating housing is enclosing the indicator. The transceiver circuitry is further configured to recondition the high speed data with clock data recovery (CDR). The electrical connector may be a USB 3.0, display port, or Thunderbolt connector.

In yet another aspect, the active cable includes: a cable body with two ends; and two cable plugs being connected to the two ends of the cable body respectively. Each cable plug includes: an electrical connector configured for transmitting and receiving power, high speed data and low speed control signals; a transceiver circuitry connected with the electrical connector and the cable body and configured to transmit and receive the high speed data between the electrical connector and the cable body; an indicator; a driving circuitry connected with the indicator and configured to drive the indicator; and a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status. The cable body includes an optical fiber, and the transceiver circuitry is configured to convert the high speed data from the electrical connector into an optical signal to be coupled into the optical fiber and to covert the optical signal from the optical fiber into an electrical data to be transmitted into the electrical connector. The pattern can be presented by a combination of on/off duty cycle, brightness and color of the indicator.

### BRIEF DESCRIPTIONS OF THE DRAWINGS

FIG. 1 shows an active cable with indicators in accordance with an embodiment of the present patent application.

FIG. 2 shows the data or signal transmission links among a host 2, a device 3 and a monitor 4 established by active cables with indicators in accordance with an embodiment of the present patent application.

FIG. 3 shows a cable plug of an active cable in accordance with an embodiment of the present patent application.

FIG. 4a shows a constant brightness on/off pattern of an indicator driving signal.

FIG. 4b illustrates a PWM control of the brightness of an LED indicator.

FIG. 5 is a flow chart illustrating the operation of an active cable according to another embodiment of the present patent application.

FIG. 6 is a block diagram of an active electrical cable according to another embodiment of the present patent application.

FIG. 7 is a block diagram of an active optical cable according to yet another embodiment of the present patent application.

FIG. 8a is a block diagram of an active hybrid cable according to still another embodiment of the present patent application.

FIG. 8b is a block diagram of an active hybrid cable according to still another embodiment of the present patent application.

FIG. 8c is a block diagram of an active hybrid cable according to still another embodiment of the present patent application.

### DETAILED DESCRIPTION

Reference will now be made in detail to a preferred embodiment of the active cable with indicators showing operating modes and linking status disclosed in the present patent application, examples of which are also provided in the following description. Exemplary embodiments of the active cable disclosed in the present patent application are described in detail, although it will be apparent to those skilled in the relevant art that some features that are not particularly important to an understanding of the active cable may not be shown for the sake of clarity.

Furthermore, it should be understood that the active cable disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

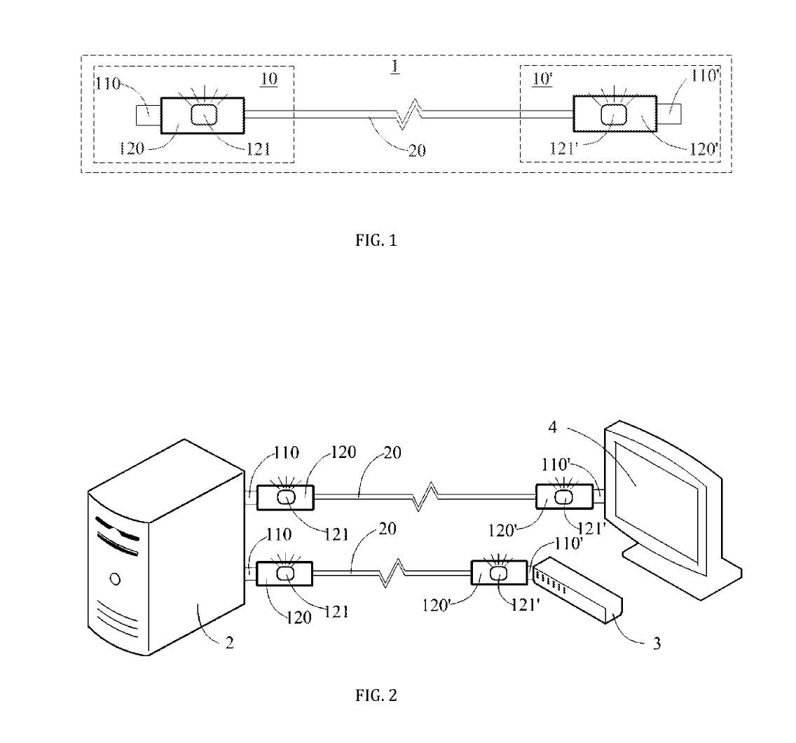

An active cable 1 with indicators in accordance with an embodiment of the present patent application is shown in FIG. 1, which includes a cable body 20 with two ends and two cable plugs 10 and 10′ being connected to the two ends of the cable body 20 respectively. Each cable plug has an electrical connector 110 and an insulating housing 120 with illumination area 121.

It should be noted that the cable body 20 may be an electrical cable with copper wires only, an optical cable with optical fibers only, or a hybrid cable with both copper wires and optical fibers.

FIG. 2 shows the data or signal transmission links among a host 2, a device 3 and a monitor 4 established by the active cables with indicators. The system can be a computer system or any data communication system.

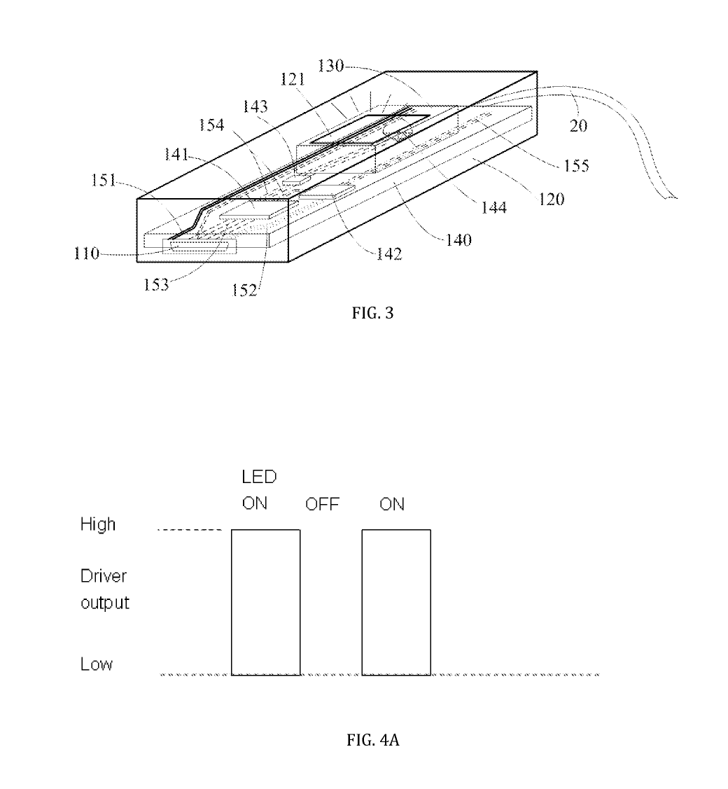

In FIG. 3, the active cable plug includes an electrical connector 110, an outer housing 120 with an illumination area 121, a light-guide 130 and a PCB 140, on which a cable controller 141, a transceiver circuitry 142, a driving circuitry 143, an indicator 144 in the form of light-emitting diode (LED), liquid-crystal display (LCD) or other electronic illumination devices are assembled.

As shown in FIG. 3, there are several types of signal paths in the active cable. The power path 151 transmits the power from the host to the cable, and optionally to the connected device, depending on the embodiments of the active cables.

The high speed signal path 152 transmits the high speed data signal. Bidirectional high speed data communication between the host and the peripheral device are carried through this path. The high speed data is transmitted from either the host or device and received by the transceiver circuitry 142 located in the connected active plug 10 through the electrical connector 110 and the high speed signal path 152. The high speed data will be processed by the transceiver circuitry 142. The data received from the host or the device will suffer from the attenuation and dispersion after running a considerably long distance of electrical connection. The data quality will be further degraded by conventional cable transmission without any active circuitry. This may increase the probability of having data error being received by the far end connected host or device. In the active cable, the high speed data will first be reconditioned by the transceiver circuitry 142 and retransmitted into the cable body 20 through the internal high speed signal path 155. As an example, the high speed data will be retimed using clock data recovery (CDR) technique to reduce the incoming data jitter, and to add pre-emphasis or de-emphasis for compensating signal attenuation along the copper wires as well as the traces on the PCB 140. Depending on the embodiment of the active cables, the transceiver circuitry 142 may also convert the high speed data into an optical signal to be coupled into the cable body 20 when optical fibers are used in the cable body 20.

Still referring to FIG. 3, on the other side of the active cable, the high speed data will be received by the transceiver circuitry 142 of the cable plug connected with the other side of the active cable. Depending on the cable embodiment, the transceiver circuitry 142 may contain the function to convert the optical signal into an electrical signal and then perform the signal reconditioning as described above. The reconditioned high speed data will be transmitted though the high speed signal path 152 and the electrical connector 110 into the connected far end host or device. This forms a one direction high speed data transmission between the host and device. High speed data transmission of the reversed direction works in a similar way.

The control signal path 153 carries the low speed control signals among the host, active cable and the device. The control signal is transmitted from either the host or device and received by the cable controller 141 located in the connected active plug 10 through the electrical connector 110 and the control signal path 153. The cable controller 141 is configured to monitor the received control signal and determine the operating modes of the cable. Depending on the embodiments, the control signal path may extend directly into the cable body 20 for active electrical cable or active hybrid cable containing the copper wires for transmitting the control signals. Alternatively, it will be processed into an optical signal and coupled into optical fibers in the cable body 20. In the case that the optical fiber is used, the cable controller 141 will resend the control signal through the internal control signal path 154. The cable controller 141 is configured to command the transceiver circuitry 142 with electrical to optical signal conversion function to retransmit the low speed control signals into the internal high speed signal path 155 using optical fibers. After determining the operating modes and link statuses, the cable controller 141 will also send out the internal control signal to the driving circuitry 143 through the internal control signal path 154 to drive the indicator 144 to illustrate the corresponding indicating patterns.

The indicator 144 is a device capable of changing its visual indication status (color, brightness, on/off duty-cycle) in accordance with the internal control signal 154 from the cable controller 141. The cable controller 141 generates the internal control signal through the internal control signal path 154 in accordance with the operating modes and link status of the active cable. The visual indication signal generated by the indicator 144 is coupled into the light-guide 130 and displayed through the illumination area 121 on the outer housing 120.

FIG. 5 is a flow chart illustrating the operation of the active cable. Referring to FIG. 5, the system first checks whether both ends of the active cable are connected to a host or device. Then the link connection starts followed by a check on whether the link connection is successful. After that, the system status is determined and the active cable enters a corresponding operating mode. The active cable is configured to display an indication pattern that corresponds with the operating mode. Then, if the system status is changed, the active cable is configured to display the indication pattern that corresponds to the new system status.

Referring to FIG. 5, in step 501, the indicator, which is an LED in this embodiment, is slowly blinking while emitting white light as an indication of a waiting status. In step 503, as an indication that a link is failed, the LED is fast blinking while emitting red light. In step 507, if the cable enters a sleep mode, the LED is turning on and off gradually while emitting white light. In this case, PWM (Pulse Width Modulation) is used to change the brightness of the LED. If the cable enters a high speed mode, the LED is constantly on and emitting white light. In this mode, there is one LED on for each channel. In the end, as shown as in step 505 in FIG. 5, the LED is turned off

It is understood that the indicator in this embodiment may be a single LED configured to emit light in different colors, a plurality of LEDs configured to emit light in different colors, or a LCD. The driving circuitry drives the indicator to display a pattern that corresponds to the operating mode and linking status. The pattern can be presented by a combination of on/off duty cycle, brightness and color of the indicator.

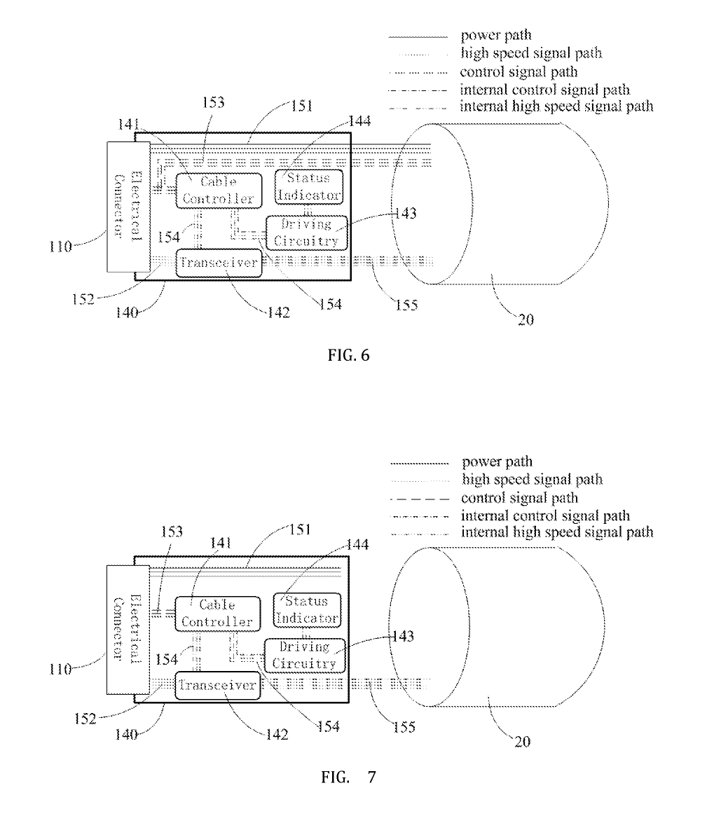

FIG. 6 is a block diagram of an active electrical cable according to another embodiment of the present patent application. For this embodiment, power path 151, internal high speed signal path 155, control signal path 153 are all carried through copper wires.

FIG. 7 is a block diagram of an active optical cable according to yet another embodiment of the present patent application. In this embodiment, referring to FIG. 7, only the internal high speed signal path 155, which is using optical fiber, exists in the cable body 20. Since there is no dedicated path for the control signal to be transmitted inside the cable, the cable controller 141 will resend the control signal through the internal control signal path 154. The cable controller 141 is configured to command the transceiver circuitry 142 with electrical to optical signal conversion function to retransmit the low speed control signals into the internal high speed signal path 155 using optical fibers. Since power cannot be transmitted through fiber, the power path 151 only provides power to the active cable plug but not delivered to the connected devices.

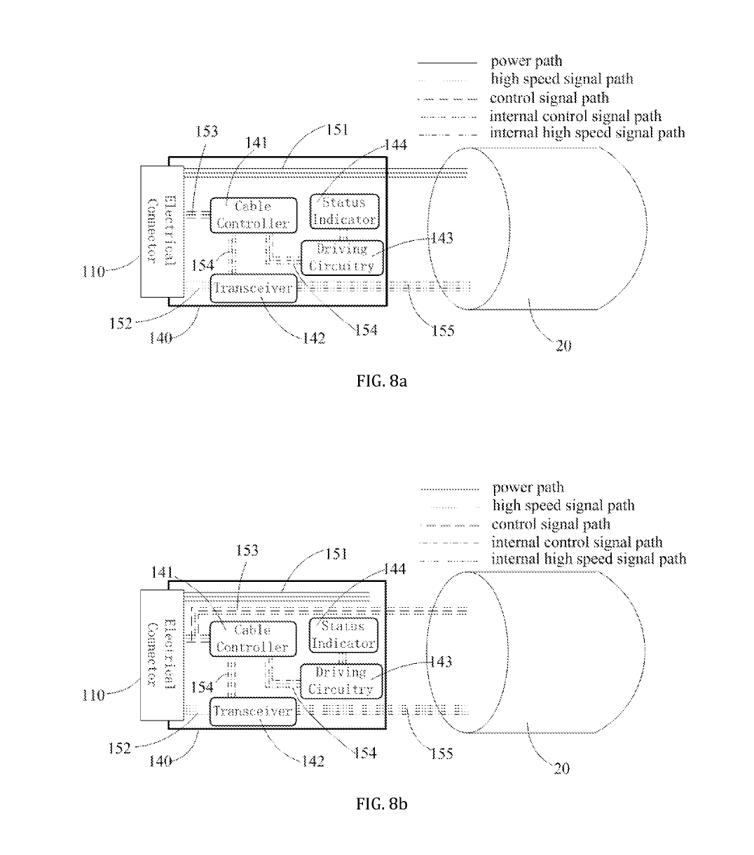

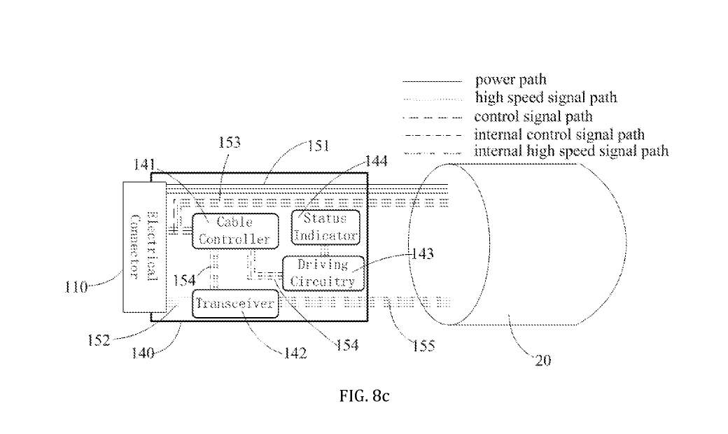

FIG. 8a is a block diagram of an active hybrid cable according to still another embodiment of the present patent application. As shown in FIG. 8a, the power path 151 is transmitted through copper wires, while the high speed signal path 155 is transmitted inside the cable body 20 using optical fibers. Applying the same method as described earlier, the control signal will be processed first by the cable controller 141 and then retransmitted in the form of low speed optical signals through the same optical fibers.

FIG. 8b is a block diagram of an active hybrid cable according to still another embodiment of the present patent application. In FIG. 8b, the control signal path 153 is transmitted through copper wires, while the internal high speed signal path 155 is transmitted through optical fibers. Since there is no power path 151 inside the cable body 20, the power path 151 only provides power to the active cable plug but not delivered to the connected devices.

FIG. 8c is a block diagram of an active hybrid cable according to still another embodiment of the present patent application. In FIG. 8c, both the power path 151 and the control signal path 153 is transmitted through copper wires, while the internal high speed signal path 155 is transmitted through optical fibers.

The active cable link status indication has the following new features: full control of the indication pattern, independent of the real data content and the system data rate; flexible and precise control of the indication pattern could be available by controlling the on/off timing and colors; unlimited number of status could be represented; no limit on the cable plug housing material used; and flexible shape of the indication logo by using light-guide.

The indicator is coupled to the light-guide design and which could be molded into any shape or meaningful logo. For example it could be a USB 3.0, display port, or thunderbolt logo or a company logo. More importantly, the user of the active cable with indicators can easily obtain information about the operating modes and link statuses of the active cable between the host and device. E.g. the end user could check whether the connection between the host and device is failed or successfully established, or in which channel of the cable the high speed data is being transmitted as well as the low speed control signals. The operating modes and link statuses indication can be achieved by means of controlling the on/off timing, brightness and colors of the indicator.

The active cable can either be an active optical cable, an active electrical cable or an active hybrid cable. This design can be applied to various systems, e.g. USB 3.0, DisplayPort, Thunderbolt.

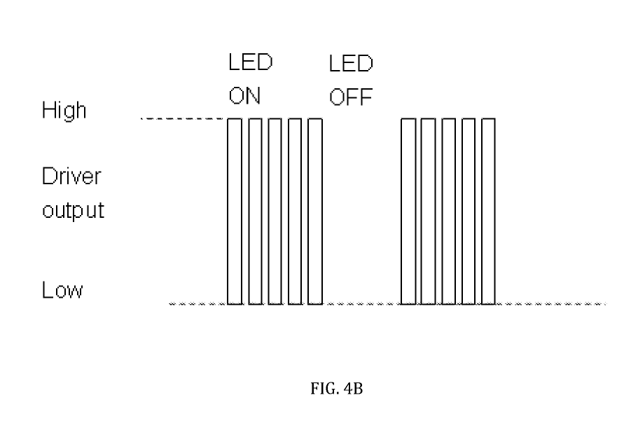

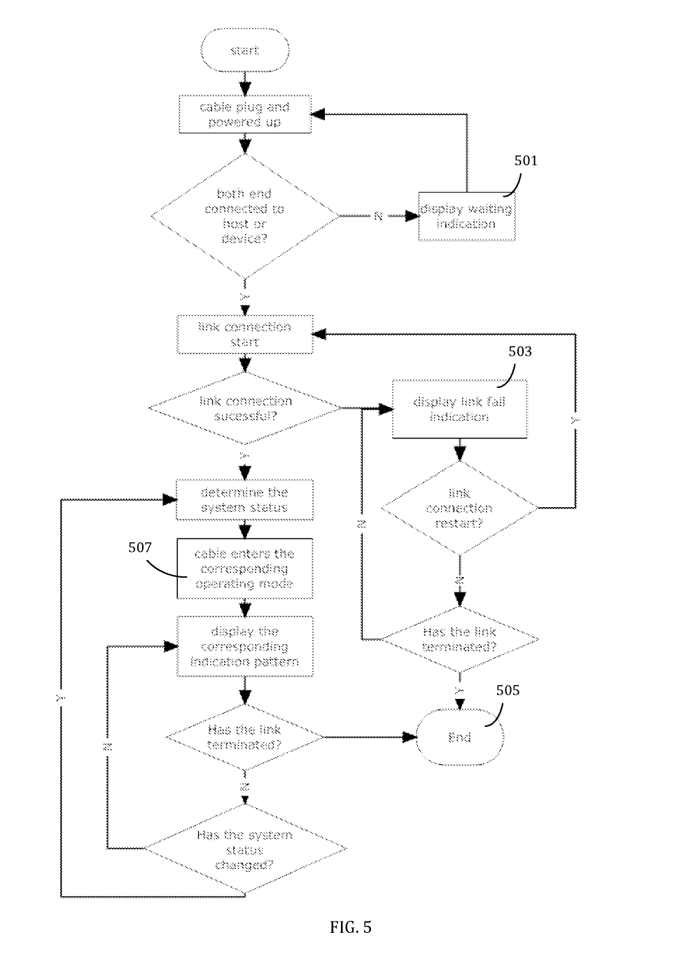

Once the active cable is connected to the host and device, the cable operating modes and link status between the host and peripheral device can be illustrated through the indicator by using different on/off timing and colors. By applying the PWM (Pulse Width Modulation) technique as described in FIG. 4A and FIG. 4B, the brightness of the indicator could also be controlled.

According to another embodiment, an active cable includes: a cable body with two ends; and two cable plugs being connected to the two ends of the cable body respectively. Each cable plug includes: an electrical connector configured for transmitting and receiving power, high speed data and low speed control signals; a transceiver circuitry connected with the electrical connector and the cable body and configured to transmit and receive the high speed data between the electrical connector and the cable body; an indicator; a driving circuitry connected with the indicator and configured to drive the indicator; and a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status.

The cable plug may further include a printed circuit board and an insulating housing. The transceiver circuitry, the indicator, the driving circuitry, and the cable controller may be assembled on the printed circuit board. The insulating housing may be enclosing the indicator.

The cable plug may further include a light guide. The insulating housing may include an illumination area. The illumination area may be aligned with the light guide and the indicator so that light emitted from the indicator passes through the light guide and transmits out from the illumination area.

The cable body may include a copper wire. The electrical connector may include a power line. The copper wire may be connected with the power line and configured to transmit electrical power. The cable body may include an optical fiber, and the transceiver circuitry may be configured to convert the high speed data from the electrical connector into an optical signal to be coupled into the optical fiber and to covert the optical signal from the optical fiber into an electrical data to be transmitted into the electrical connector. The cable controller may be configured to command the transceiver circuitry to transmit and receive a low speed control signal through the optical fiber.

The cable body may include a copper wire being connected with the electrical connector and configured for transmitting and receiving high speed data. The cable body may include a copper wire being connected with the electrical connector and the cable controller and configured for transmitting and receiving a low speed control signal.

The transceiver circuitry may be further configured to recondition the high speed data with clock data recovery (CDR). The indicator may be a light-emitting diode (LED) or a liquid-crystal display (LCD). The pattern may be presented by a combination of on/off duty cycle, brightness and color of the indicator. The cable controller may be configured to transmit an internal control signal to the driving circuitry to control the brightness of the indicator using PWM (Pulse Width Modulation). The electrical connector may be a USB 3.0, display port, or Thunderbolt connector.

The active cable with indicators provided by the above embodiments has the capability to indicate the operation modes and link status of the cable. Some examples of cable operation modes and link status information include whether the link between the host and device are successfully established; operating modes of the active cable, e.g. the active mode, the idle mode, and the sleep mode; and indication on which channel the data is being transmitted.

A light-guide is used to collect and re-distribute the light emitted by the indicator. The housing does not need to be transparent. This makes the cable easier to meet the specification requirement which certain color or material has to be used and gives the designers more flexibility to design the outlook.

Unlimited types of status can be illustrated by a combination of on/off/flash of the indicator, brightness and color of the indicator. Precise control of the indication pattern could be available by controlling the on/off timing and colors. Unlimited number of status could be represented. It is understood that there is no limit on what kinds of cable material used. It could either be an active electrical cable or an optical cable, or an active hybrid cable.

The cable controller in the above embodiments may be implemented by any programmable logic controller. The controller in this patent application is referring to a logical unit, and it could be in any form factor and not limited to a single packaged device. It is configured to communicate with the system and drive the active cable into different operating modes, and to control or monitor the data transmission. The cable controller will control the indicator to show different indication pattern correspondently. The indication pattern is independent of the real data content transmitting and the system data rate.

While the present patent application has been shown and described with particular references to a number of embodiments thereof, it should be noted that various other changes or modifications may be made without departing from the scope of the present invention.

What is claimed is:

1. An active cable comprising:
a cable body with two ends; and
two cable plugs being connected to the two ends of the cable body respectively, each cable plug comprising:
an electrical connector configured for transmitting and receiving power, high speed data and low speed control signals;
a transceiver circuitry connected with the electrical connector and the cable body and configured to transmit and receive the high speed data between the electrical connector and the cable body;
an indicator;
a driving circuitry connected with the indicator and configured to drive the indicator; and
a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status.

2. The active cable of claim 1, wherein the cable plug further comprises a printed circuit board and an insulating housing, the transceiver circuitry, the indicator, the driving circuitry, and the cable controller being assembled on the printed circuit board, and the insulating housing being enclosing the indicator.

3. The active cable of claim 2, wherein the cable plug further comprises a light guide, the insulating housing comprising an illumination area, the illumination area being aligned with the light guide and the indicator so that light emitted from the indicator passes through the light guide and transmits out from the illumination area.

4. The active cable of claim 1, wherein the cable body comprises a copper wire, the electrical connector comprises a power line, and the copper wire is connected with the power line and configured to transmit electrical power.

5. The active cable of claim 1, wherein the cable body comprises an optical fiber, and the transceiver circuitry is configured to convert the high speed data from the electrical connector into an optical signal to be coupled into the optical fiber and to covert the optical signal from the optical fiber into an electrical data to be transmitted into the electrical connector.

6. The active cable of claim 5, wherein the cable controller is configured to command the transceiver circuitry to transmit and receive a low speed control signal through the optical fiber.

7. The active cable of claim 1, wherein the cable body comprises a copper wire being connected with the transceiver circuitry and configured for transmitting and receiving high speed data.

8. The active cable of claim 1, wherein the cable body comprises a copper wire being connected with the electrical connector and the cable controller and configured for transmitting and receiving a low speed control signal.

9. The active cable of claim 1, wherein the transceiver circuitry is further configured to recondition the high speed data with clock data recovery (CDR).

10. The active cable of claim 1, wherein the indicator is a light-emitting diode (LED) or a liquid-crystal display (LCD).

11. The active cable of claim 1, wherein the pattern can be presented by a combination of on/off duty cycle, brightness and color of the indicator.

12. The active cable of claim 11, wherein the cable controller is configured to transmit an internal control signal to the driving circuitry to control the brightness of the indicator using PWM (Pulse Width Modulation).

13. An active cable comprising:
a cable body with two ends; and
two cable plugs being connected to the two ends of the cable body respectively, each cable plug comprising:
an electrical connector configured for transmitting and receiving power, high speed data and low speed control signals;
a transceiver circuitry connected with the electrical connector and the cable body and configured to transmit and receive the high speed data between the electrical connector and the cable body;
an indicator;
a driving circuitry connected with the indicator and configured to drive the indicator;
a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status;
a printed circuit board; and
an insulating housing; wherein:
the transceiver circuitry, the indicator, the driving circuitry, and the cable controller are assembled on the printed circuit board;
the insulating housing is enclosing the indicator; and
the transceiver circuitry is further configured to recondition the high speed data with clock data recovery (CDR).

14. The active cable of claim 13, wherein the cable plug further comprises a light guide, the insulating housing comprising an illumination area, the illumination area being aligned with the light guide and the indicator so that light emitted from the indicator passes through the light guide and transmits out from the illumination area.

15. The active cable of claim 13, wherein the cable body comprises a copper wire, the electrical connector comprises a power line, and the copper wire is connected with the power line and configured to transmit electrical power.

16. The active cable of claim 13, wherein the cable body comprises an optical fiber, and the transceiver circuitry is configured to convert the high speed data from the electrical connector into an optical signal to be coupled into the optical fiber and to covert the optical signal from the optical fiber into an electrical data to be transmitted into the electrical connector.

17. The active cable of claim 16, wherein the cable controller is configured to command the transceiver circuitry to transmit and receive a low speed control signal through the optical fiber.

18. The active cable of claim 13, wherein the cable body comprises a copper wire being connected with the transceiver circuitry and configured for transmitting and receiving high speed data.

19. The active cable of claim 13, wherein the electrical connector is a USB 3.0, display port, or Thunderbolt connector.

20. An active cable comprising:
a cable body with two ends; and
two cable plugs being connected to the two ends of the cable body respectively, each cable plug comprising:
an electrical connector configured for transmitting and receiving power, high speed data and low speed control signals;
a transceiver circuitry connected with the electrical connector and the cable body and configured to transmit and receive the high speed data between the electrical connector and the cable body;
an indicator;
a driving circuitry connected with the indicator and configured to drive the indicator; and
a cable controller connected with the electrical connector, the transceiver circuitry and the driving circuitry and configured to determine an operating mode and linking status of the active cable and transmit an internal control signal to the driving circuitry so that the driving circuitry drives the indicator to display a pattern that corresponds to the operating mode and linking status; wherein:
the cable body comprises an optical fiber, and the transceiver circuitry is configured to convert the high speed data from the electrical connector into an optical signal to be coupled into the optical fiber and to covert the optical signal from the optical fiber into an electrical data to be transmitted into the electrical connector; and
the pattern can be presented by a combination of on/off duty cycle, brightness and color of the indicator.
